(19) United States
(12) Patent Application Publication
(10) Pub. No.: US 2011/0065580 A1
(43) Pub. Date: Mar. 17, 2011

(54) Use of Succinate Dehyrogenase Inhibitors for Increasing the Content of Desired Ingredients in Crops

(75) Inventors: Heiko RIECK, Burscheid (DE); Hélène LACHAISE, Lyon (FR); Gilbert LABOURDETTE, Paray Le Monial (FR); Dominique STEIGER, Dusseldorf (DE)

(73) Assignee: Bayer CropScience AG, Monheim (DE)

(21) Appl. No.: 12/882,963

(22) Filed: Sep. 15, 2010

Related U.S. Application Data
(60) Provisional application No. 61/243,195, filed on Sep. 17, 2009.

(30) Foreign Application Priority Data
Sep. 16, 2009 (EP) 09170440.3

(51) Int. Cl. A01N 43/40; A01P 3/00

(52) U.S. Cl. 504/130; 504/244

(57) ABSTRACT

The present invention relates to the use of succinate dehydrogenase Inhibitors for increasing the content of desired ingredients in crops, such as fruits and vegetables and to a method for increasing the content of desired ingredients in crops by applying a succinate dehydrogenase inhibitor to the crops prior to the harvest of the crop or of its fruits or vegetables.

The present invention relates to the use of succinate dehydrogenase Inhibitors for increasing the content of desired ingredients in crops, such as fruits and vegetables and to a method for increasing the content of desired ingredients in crops by applying a succinate dehydrogenase inhibitor to the crops prior to the harvest of the crop or of its fruits or vegetables.

Providing for the nutritional well-being of a rapidly growing world population is one of the greatest challenges facing the global human community. In view of limited and decreasing acreages it is necessary to improve the nutritional capacities and the quality of cultivated crops. This goal could be achieved by increasing the content of nutritional ingredients of the crops, such as sugar-, vitamin-, starch- or fat/oil content.

The object underlying the present invention is the provision of a method for increasing the content of desired ingredients in crops.

The problem outlined above has been solved by the use of succinate dehydrogenase inhibitors for increasing the content of desired ingredients in crops.

It has surprisingly been found that the application of succinate dehydrogenase inhibitors during the growing and maturation periods increases the content of desired ingredients in crops or of the fruits and vegetables obtained from those crops.

In conjunction with the present invention “increasing the content” means that the treated crop or fruits and vegetables harvested from the treated crop have a higher content of a specific desired ingredient as compared to an untreated crop or to fruits or vegetables obtained therefrom.

“Desired ingredients” are all materials which positively a contribute to the economic or nutritional value of a crop or of fruits and vegetables obtained from that crop.

A non-exhaustive enumeration of desired ingredients shall be given subsequently:

Polyphenols are a group of chemical substances found in plants, characterized by the presence of more than one phenol unit or building block per molecule. Polyphenols are generally divided into hydrolyzable tannins (gallic acid esters of glucose and other sugars) and phenylpropanoids, such as lignins, flavonoids, and condensed tannins.

Anthocyanins are water-soluble vacuolar pigments that may appear red, purple, or blue according to pH. They belong to a parent class of molecules called flavonoids synthesized via the phenylpropanoid pathway. Anthocyanins occur in all tissues of higher plants, including leaves, stems, roots, flowers, and fruits.

Anthocyanidins are common plant pigments. They are the sugar-free counterparts of anthocyanins based on the benzopyrylium (chromenylium) ion. They form a large group of polymethine dye. In particular anthocyanidins are salt derivatives of the 2-phenylchromenylium cation, also known as flavylium cation. As shown in the figure below, the phenyl group at the 2-position, can carry different substituents. The counterion of the flavylium cation is mostly chloride. With this positive charge, the anthocyanidins differ from other flavonoids.

Vegetable fats and oils are lipid materials derived from plants. Physically, oils are liquid at room temperature, and fats are solid. Chemically, both fats and oils are composed of triglycerides, as contrasted with waxes which lack glycerin in their structure. Although many different parts of plants may yield oil, in commercial practice, oil is extracted primarily from seeds.

Essential fatty acids are polyunsaturated fatty acids and are the parent compounds of the omega-6 and omega-3 fatty acid series, respectively. They are essential in the human diet because there is no synthetic mechanism for them. Humans can easily make saturated fatty acids or monounsaturated fatty acids with a double bond at the omega-9 position, but do not have the enzymes necessary to introduce a double bond at the omega-3 position or omega-6 position. Due to its nutritional value it is desired to increase the unsaturated fatty acid content of crops. More preferably it is desired to increase the content of myristoleic acid, palmitoleic acid, oleic acid, linoleic acid, α-linolenic acid, arachidonic acid, eicosapentaenoic acid, erucic acid and docosahexaenoic acid.

Sugar denotes all mono-, di-, oligo- and polysaccharides usually contained in crops. Particularly preferred sugars are starch, glucose, fructose and sucrose.

Fruit acids are a group of organic acids that share a common chemical structure consisting of a hydroxyl group positioned at the alpha-carbon position. Consequently, these compounds are often referred to as alpha hydroxy acids. Common fruit acids include lactic and malic acids. Because of the structural configuration of these acids, they are optically active and only certain forms of the isomers are obtained from natural sources.

The sugar/acid ratio contributes towards giving many fruits their characteristic flavour. So it is an indicator of commercial and organoleptic ripeness. At the beginning of the ripening process the sugar/acid ratio is low, because of low sugar content and high fruit acid content, this makes the fruit taste sour. During the ripening process the fruit acids are degraded, the sugar content increases and the sugar/acid ratio achieves a higher value. Overripe fruits have very low levels of fruit acid and therefore lack characteristic flavour.

Thus, it is desirable to maintain a balanced sugar/acid ratio even at the time of harvest of the fruits.

Vitamins are organic compounds required as a nutrient in tiny amounts by an organism. A compound is called a vitamin when it cannot be synthesized in sufficient quantities by an organism, and must be obtained from the diet. Thus, the term is conditional both on the circumstances and the particular organism. According to the present invention the vitamin is selected from the group consisting of retinoids and carotenoids (vitamin A), thiamine (vitamin B₁), riboflavin (vitamin B₂), niacin, niacinamide (vitamin B₃), pantothenic acid (vitamin B₅), pyridoxine, pyridoxamine, pyridoxal (vitamin B₆), biotin (vitamin B₇), folic acid, folinic acid (vitamin B₉), ascorbic acid (vitamin C), tocopherols, tocotrienols (vitamin E), phylloquinone, menaquinones (vitamin K).

### Succinate Dehydrogenase Inhibitors

In conjunction with the present invention all active substances (a.s.) which inhibit succinate dehydrogenase in the mitochondrial respiration chain can be used. In a preferred embodiment of the present invention the succinate dehydrogenase inhibitor is selected from the group consisting of fluopyram, isopyrazam, boscalid, penthiopyrad, penflufen, sedaxan and bixafen or mixtures thereof. In a most preferred embodiment of the present invention the succinate dehydrogenase inhibitor is fluopyram.

Fluopyram having the chemical name N-{[3-chloro-5-(trifluoromethyl)-2-pyridinyl]ethyl}-2,6-dichlorobenzamide is a fungicide belonging to the chemical class of pyridylethylbenzamides. Fluopyram and its manufacturing process starting from known and commercially available compounds is described in EP-A-1 389 614.

Penflufen having the chemical name N-[2-(1,3-dimethylbutyl)phenyl]-5-fluoro-1,3-dimethyl-1H-pyrazole-4-carboxamide and its manufacturing process starting from known and commercially available compounds is described in WO 03/010149.

Bixafen having the chemical name N-(3′,4′-dichloro-5-fluoro-1,1′-biphenyl-2-yl)-3-(difluoromethyl)-1-methyl-1H-pyrazole-4-carboxamide (Compound I-2) and its manufacturing process starting from known and commercially available compounds is described in WO 03/070705.

Sedaxane is the mixture of 2 cis-isomers 2′-[(1RS,2RS)-1,1′-bicycloprop-2-yl]-3-(difluoromethyl)-1-methylpyrazole-4-carboxanilide and 2 trans-isomers 2′-[(1RS,2SR)-1,1′-bicycloprop-2-yl]-3-(difluoromethyl)-1-methylpyrazole-4-carboxanilide Sedaxane and its manufacturing process starting from known and commercially available compounds is described in WO 03/074491, WO 2006/015865 and WO 2006/015866.

Isopyrazam is the mixture of 2 syn-isomers 3-(difluoromethyl)-1-methyl-N-[(1RS,4SR,9RS)-1,2,3,4-tetrahydro-9-isopropyl-1,4-methanonaphthalen-5-yl]pyrazole-4-carboxamide and 2 anti-isomers 3-(difluoromethyl)-1-methyl-N-[(1RS,4SR,9SR)-1,2,3,4-tetrahydro-9-isopropyl-1,4-methanonaphthalen-5-yl]pyrazole-4-carboxamide. Isopyrazam and its manufacturing process starting from known and commercially available compounds is described in WO 2004/035589.

Penthiopyrad having the chemical name (RS)—N-[2-(1,3-dimethylbutyl)-3-thienyl]-1-methyl-3-(trifluoromethyl)pyrazole-4-carboxamide and its manufacturing process starting from known and commercially available compounds is described in EP-A-0 737 682.

Boscalid having the chemical name 2-chloro-N-(4′-chlorobiphenyl-2-yl)nicotinamide and its manufacturing process starting from known and commercially available compounds is described in DE-A 195 31 813.

3-(Difluoromethyl)-1-methyl-N-(3′,4′,5′-trifluorobiphenyl-2-yl)-1H-pyrazole-4-carboxamide and its manufacturing process starting from known and commercially available compounds is described in WO 2006/087343.

In a preferred embodiment of the invention the succinate dehydrogenase inhibitor is fluopyram.

The use/method according to the present invention can be applied to any kind of crops or fruits and vegetables obtained therefrom.

Examples for crops which can be treated according to the present invention are selected from the group consisting of cotton; flax; vine; fruit or vegetable crops such as Ericaceae sp., including instance cranberry, blueberry, bilberry and huckleberry; Brassicaceae sp. (for instance cabbage, broccoli, cauliflower, turnip, Chinese cabbage, Brussels sprouts, rapeseed, canola, radish and horseradish), Prunaceae sp. (Amygdalaceae) including plum, cherry, apricot, peach, and almond; Maloideae sp. (Pomoideae) including apple, pear, quince, rowan, loquat; Ribesioidae sp., Juglandaceae sp., Betulaceae sp., Anacardiaceae sp. (for instance mango, sumac, marula and pistachio), Fagaceae sp., Moraceae sp., Oleaceae sp., Actimidaceae sp., Lauraceae sp., Musaceae sp. (for instance banana and plantins), Rubiaceae sp. including coffee and borojo, Theaceae sp., Sterculiceae sp., Rutaceae sp. (for instance lemons, lime, oranges and grapefruit); Liliaceae sp., Asteraceae sp. (for instance lettuces), Umbelliferae sp., Cruciferae sp., Chenopodiaceae sp., Cucurbitaceae sp. (for instance melons, gourds, cucurbits, cucumbers, squashes, pumpkins, winter squash, luffas, melons and watermelons), Papilionaceae sp. (for instance peas), Rosaceae sp. (for instance strawberries, blackberry, raspberry, boysenberry); major crops such as Graminae sp. (for instance maize, lawn or cereals such as wheat, rye, rice, barley and triticale), Asteraceae sp. (for instance sunflower), Cruciferae sp. (for instance colza), Fabacae sp. (for instance peanuts), Papilionaceae sp. (for instance soybean), Solanaceae sp. (for instance potatoes, eggplant, capsicum, paprika, chili pepper, potato, tobacco), Chenopodiaceae sp. (for instance beetroots, spinach, chard); sugarcane (Saccharum spp.), sugar beets (Beta vulgaris), date palm (Phoenix dactylifera), sorghum (Sorghum vulgare) and sugar maple (Acer saccharum), alfalfa, yerba mate, borojo, cocoa tea, green bean, fig, pineapple, hedge apple, mulberry, kiwifruit, guava, lucuma, pomegranate, blackcurrant, redcurrant, gooseberry, papaya, globe artichokes, sweetcorn, kale, collard greens, beet greens, turnip greens, endive; leeks, celery, rhubarb, asparagus, ginger; Jerusalem artichokes, sweet potato, yam bean sprouts, carrots, parsnips, beets, turnips, onions, garlic, shallots, palm, soybean, cotton seed, palm kernel, corn, sunflower seed, peanut, coconut, hazelnut, walnut and other nuts, linseed, rice, sesame, canola and olive horticultural and forest crops; as well as genetically modified homologues of these crops.

Examples for fruits are banana, blackcurrant, redcurrant, gooseberry, tomato, eggplant, guava, lucuma, chili pepper, pomegranate, kiwifruit, grape, table grapes, pumpkin, gourd, cucumber, melon, orange, lemon, lime, grapefruit, banana, cranberry, blueberry, blackberry, raspberry, boysenberry, hedge apple, pineapple, date, fig, mulberry, apple, apricot, peach, cherry, green bean, sunflower seed, strawberry and plum.

Examples for vegetables are flower buds, such as: broccoli, cauliflower, globe artichokes; seeds, such as sweetcorn also known as maize; leaves, such as kale, collard greens, spinach, beet greens, turnip greens, endive; leaf sheaths, such as leeks; buds, such as Brussels sprouts; stems of leaves, such as celery, rhubarb; stem of a plant when it is still a young shoot, such as asparagus, ginger; underground stem of a plant, also known as a tuber, such as potatoes, Jerusalem artichokes, sweet potato, yam; whole immature plants, such as bean sprouts; Roots, such as carrots, parsnips, beets, radishes, turnips; bulbs, such as onions, garlic, shallots.

In conjunction with the present invention the terms “crops” and “plants” can be used inter-changeably, both encompass fruits and vegetables obtainable from those crops or plants.

The use/method according present invention can be employed for increasing the oil or fat content of palm, soybean, rapeseed, cotton seed, palm kernel, corn, sunflower seed, peanut, coconut, hazelnut, walnut and other nuts, linseed, rice, sesame and olive.

Moreover, it has been found that the treatment of palm, soybean, rapeseed, cotton seed, palm kernel, corn, sunflower seed, peanut, coconut, hazelnut, walnut and other nuts, linseed, rice, sesame and olive plants, increases their unsaturated fatty acid content. Particularly their content of myristoleic acid, palmitoleic acid, oleic acid, linoleic acid, α-linolenic acid, arachidonic acid, eicosapentaenoic acid, erucic acid and docosahexaenoic acid is increased.

Likewise, the use/method according present invention can be employed for increasing the polyphenol content of crops, particularly the content of tannins, lignins and flavonoids, such as flavonols, flavones, catechins, flavanones, anthocyanidins isoflavonoids and quercetin of berries, such as cranberry, blueberry, bilberry and huckleberry, blackcurrant, redcurrant, gooseberry; tea, grapes/wine, olive, cocoa, coffee, walnuts, peanuts, borojo, pomegranates and yerba mate.

In another embodiment the use/method according present invention can be employed for increasing the sugar content of crops. More particularly the invention can be used to increase
the sucrose content, of sugarcane (Saccharum spp.), sugar beets (Beta vulgaris), date palm (Phoenix dactylifera), sorghum (Sorghum vulgare) and sugar maple (Acer saccharum);
the starch content of maize, rice, wheat, cassava (maniok), corn husk and sago;
the glucose content of apple, apricot, banana, grapes, peach, pear, beet (red), carrot, corn (sweet), red pepper, sweet onion, sweet potato, yam, sugarcane and sugar beet.
the fructose content of apple, apricot, banana, grapes, peach, pear, beet (red), carrot, corn (sweet), red pepper, sweet onion, sweet potato, yam, sugarcane and sugar beet.

In a further embodiment of the invention the use/method according present invention can be employed for increasing the vitamin content of crops.

More particularly, the present invention can be used for increasing the content of
retinoids and carotenoids (vitamin A) in sweet potato, carrot, broccoli, kale, spinach, leafy vegetables, pumpkin, collard greens, cantaloupe melon, apricot, papaya, mango, pea, broccoli, winter squash;
thiamine (vitamin B₁) in oat, flax, sunflower seeds, rice, rye, asparagus, kale, cauliflower, potatoes and oranges;
riboflavin (vitamin B₂) in asparagus, bananas, persimmons, okra, chard;
niacin, niacinamide (vitamin B₃) in avocados, dates, tomatoes, leaf vegetables, broccoli, carrots, sweet potatoes, asparagus;
pantothenic acid (vitamin B₅) in broccoli, avocados rice, wheat, alfalfa, peanut;
pyridoxine, pyridoxamine, pyridoxal (vitamin B₆) in cereals and nuts;
biotin (vitamin B₇) in legumes, soybeans, swiss chard, tomatoes, romaine lettuce, carrots, almonds, onions, cabbage, cucumber, cauliflower, raspberries, strawberries, oats, walnuts, oilseed meals, alfalfa;
folic acid, folinic acid (vitamin B₉) in spinach, asparagus, turnip greens, lettuces, dried or fresh beans and peas, fortified cereal products, sunflower seeds;
ascorbic acid (vitamin C) in Indian gooseberry, blackcurrant, red pepper, parsley, guava, kiwifruit, passion fruit;
tocopherols, tocotrienols (vitamin E) in asparagus, avocado, nuts, such as almonds or hazelnuts, palm oil, seeds, spinach and other green leafy vegetables, canola, corn, sun-flower, soybean, cottonseed, olive oil, rice, wheat, cereals
phylloquinone, menaquinones (vitamin K) in soybean spinach, swiss chard, parsley and Brassica (e.g. cabbage, kale, cauliflower, broccoli, and brussels sprouts); fruits such as avocado and kiwifruit
polyphenols, particularly the content of tannins, lignins and flavonoids, such as flavonols, flavones, catechins, flavanones, anthocyanidins isoflavonoids and quercetin in grapes and wine
anthocyanins in strawberries.

The succinate dehydrogenase inhibitors, preferably fluopyram, can be employed for increasing the content of desired ingredients in crops within a certain period of time after the treatment of the crops or after treating the fruits or vegetables itself. Generally, the succinate dehydrogenase inhibitor is applied to the crop or to its fruits or vegetables prior to the harvest, more preferably prior to the maturation of fruits and vegetables, most preferably during the plant and fruit growth.

The period of time within which an increase of the desired ingredients is effected generally extends from 1 hour to 6 months, preferably from 1 day to 3 month, more preferably from 1 week to 1 month, most preferably from 2 weeks to 1 month after the treatment of the crops or its fruits or vegetables with the active compounds.

When employing the succinate dehydrogenase inhibitors, preferably fluopyram, according to the present invention for increasing the content of desired ingredients in crops, the application rates can be varied within a broad range, depending on the type of application. For foliar applications the application rates of active compound are generally ranging from 1 to 250 g/ha, more preferably from 25 to 200 g/ha, most preferably from 30 to 150 g/ha based upon the pure a.s. (active substance).

According to the present invention the succinate dehydrogenase inhibitor, preferably fluopyram, can be applied to all parts of the plants such as shoot, leaf, flower and root, leaves, needles, stalks, stems, flowers, vegetative buds and flower buds, fruiting bodies and fruits. By plant parts is meant all above ground and below ground parts and organs of plants such as shoot, leaf, blossom and root, whereby for example leaves, needles, stems, branches, blossoms, fruiting bodies, fruits and seed as well as roots, corms and rhizomes are listed. Crops and vegetative and generative propagating material, for example cuttings, corms, rhizomes, runners and seeds also belong to plant parts.

Plants are understood as meaning, in the present context, all plants and plant populations, such as desired and undesired wild plants or crop plants (including naturally occurring crop plants). By plants is meant all plants and plant populations such as desirable and undesirable wild plants, cultivars and plant varieties (whether or not protectable by plant variety or plant breeder's rights). Cultivars and plant varieties can be plants obtained by conventional propagation and breeding methods which can be assisted or supplemented by one or more biotechnological methods such as by use of double haploids, protoplast fusion, random and directed mutagenesis, molecular or genetic markers or by bioengineering and genetic engineering methods or marker-assisted breeding methods, for example SMART breeding (“Selection with Markers and Advanced Reproductive Technologies”). Crop plants or crops may be plants which can be obtained by conventional breeding and optimization methods or else by biotechnological and genetic engineering methods or by combinations of these methods, including the transgenic plants and including the plant varieties capable or not capable of being protected by plant breeders' rights.

Plants and plant cultivars include all plants which have genetic material which impart particularly advantageous, useful traits to these plants (whether obtained by breeding and/or biotechnological means).

Plants and plant cultivars are resistant against one or more biotic stresses, i.e. said plants show a better defense against animal and microbial pests, such as against nematodes, insects, mites, phytopathogenic fungi, bacteria, viruses and/or viroids.

Plants and plant cultivars are those plants which are resistant to one or more abiotic stresses. Abiotic stress conditions may include, for example, drought, cold temperature exposure, heat exposure, osmotic stress, flooding, increased soil salinity, increased mineral exposure, ozon exposure, high light exposure, limited availability of nitrogen nutrients, limited availability of phosphorus nutrients, shade avoidance.

Plants and plant cultivars are those plants characterized by enhanced yield characteristics. Increased yield in said plants can be the result of, for example, improved plant physiology, growth and development, such as water use efficiency, water retention efficiency, improved nitrogen use, enhanced carbon assimilation, improved photosynthesis, increased germination efficiency and accelerated maturation. Yield can furthermore be affected by improved plant architecture (under stress and non-stress conditions), including but not limited to, early flowering, flowering control for hybrid seed production, seedling vigor, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content, protein content, oil content and composition, nutritional value, reduction in anti-nutritional compounds, improved processability and better storage stability.

Plants are hybrid plants that already express the characteristic of heterosis or hybrid vigor which results in generally higher yield, vigor, health and resistance towards biotic and abiotic stress factors. Such plants are typically made by crossing an inbred male-sterile parent line (the female parent) with another inbred male-fertile parent line (the male parent). Hybrid seed is typically harvested from the male sterile plants and sold to growers. Male sterile plants can sometimes (e.g. in corn) be produced by detasseling, i.e. the mechanical removal of the male reproductive organs (or males flowers) but, more typically, male sterility is the result of genetic determinants in the plant genome. In that case, and especially when seed is the desired product to be harvested from the hybrid plants it is typically useful to ensure that male fertility in the hybrid plants is fully restored. This can be accomplished by ensuring that the male parents have appropriate fertility restorer genes which are capable of restoring the male fertility in hybrid plants that contain the genetic determinants responsible for male-sterility. Genetic determinants for male sterility may be located in the cytoplasm. Examples of cytoplasmic male sterility (CMS) were for instance described in Brassica species. However, genetic determinants for male sterility can also be located in the nuclear genome. Male sterile plants can also be obtained by plant biotechnology methods such as genetic engineering. A particularly useful means of obtaining male-sterile plants is described in WO 1989/10396 in which, for example, a ribonuclease such as barnase is selectively expressed in the tapetum cells in the stamens. Fertility can then be restored by expression in the tapetum cells of a ribonuclease inhibitor such as barstar.

Plants or plant cultivars (obtained by plant biotechnology methods such as genetic engineering) are herbicide-tolerant plants, i.e. plants made tolerant to one or more given herbicides. Such plants can be obtained either by genetic transformation, or by selection of plants containing a mutation imparting such herbicide tolerance.

Plants or plant cultivars (obtained by plant biotechnology methods such as genetic engineering) are insect-resistant transgenic plants, i.e. plants made resistant to attack by certain target insects. Such plants can be obtained by genetic transformation, or by selection of plants containing a mutation imparting such insect resistance.

According to the invention the treatment of the plants with the succinate dehydrogenase inhibitors, preferably fluopyram, is carried out directly by the customary treatment methods, for example by immersion, spraying, vaporizing, fogging, injecting, dripping, drenching, broadcasting or painting. In a preferred embodiment of the invention fluopyram is applied by injecting, dripping, drenching or spraying.

The succinate dehydrogenase inhibitors, preferably fluopyram, can be converted to the customary formulations, such as solutions, emulsions, suspensions, powders, foams, pastes, granules, aerosols, very fine capsules in polymeric substances and in coating compositions for seed, and also ULV cold- and warm-fogging formulations.

These formulations are produced in a known manner, for example by mixing the active compounds with extenders, that is liquid solvents, pressurized liquefied gases and/or solid carriers, optionally with the use of surface-active agents, that is emulsifiers and/or dispersants and/or foam formers. If the extender used is water, it is also possible to employ for example organic solvents as cosolvents. Suitable liquid solvents are essentially: aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example mineral oil fractions, alcohols, such as butanol or glycol as well as their ethers and esters, ketones, such as acetone, methyl ethyl ketone, methyl isobutyl ketone or cyclohexanone, strongly polar solvents, such as dimethylformamide and dimethyl sulphoxide, and also water. Liquefied gaseous extenders or carriers are those liquids which are gaseous at ambient temperature and at atmospheric pressure, for example aerosol propellants such as halogenated hydrocarbons and also butane, propane, nitrogen and carbon dioxide. As solid carriers there are suitable: for example ground natural minerals, such as kaolins, clays, talc, chalk, quartz, attapulgite, montmorillonite or diatomaceous earth, and ground synthetic minerals, such as finely divided silica, alumina and silicates. As solid carriers for granules there are suitable: for example crushed and fractionated natural rocks such as calcite, pumice, marble, sepiolite and dolomite, and also synthetic granules of inorganic and organic meals, and granules of organic material such as sawdust, coconut shells, maize cobs and tobacco stalks. As emulsifiers and/or foam formers there are suitable: for example non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and protein hydrolysates. As dispersants, for example, lignosulphite waste liquors and methylcellulose are suitable.

Tackifiers such as carboxymethylcellulose and natural and synthetic polymers in the form of powders, granules or latices, such as gum arabic, polyvinyl alcohol and polyvinyl acetate, as well as natural phospholipids, such as cephalins and lecithins, and synthetic phospholipids, can be used in the formulations. Other possible additives are mineral and vegetable oils.

It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

The formulations in general contain between 0.1 and 95 percent by weight of active compounds, preferably between 0.5 and 90 percent by weight, based upon the total formulation.

According to the present invention, the succinate dehydrogenase inhibitors, preferably fluopyram, as such or their formulations, can also be used as a mixture with known fungicides, bactericides, acaricides, nematicides, or insecticides, for example, to broaden the activity spectrum or prevent the development of resistance. In many instances, synergistic effects are obtained, i.e. the activity of the mixture exceeds the activity of the individual components.

A further embodiment of the invention relates to the use of a composition comprising a succinate dehydrogenase inhibitor, preferably fluopyram, and a second fungicide increasing the content of desired ingredients in crops.

A further embodiment of the present invention pertains to a method for increasing the content of desired ingredients in crops, characterized in that, fluopyram was applied to the crop prior to the harvest of the fruits and vegetables.

The present invention is exemplified by the following examples.

### EXAMPLES

### Example A

### Strawberry

A trial was performed to measure the effects of 2 sprays of Fluopyram based formulations on quality parameters on fruits at harvest and in storage.

The two sprays are realized 10 days and 3 days before picking stage.

Fruits of strawberry ‘Senga Sengana’ cv were harvested twice (on 25^{th} and 29^{th} of June 2009). After harvest fruits were randomly divided into three subsamples—one was frozen, disintegrated in the frozen state and kept at −24° C. for organic acids, ascorbic acid, total phenolics and anthocyanins analysis; second was used for analyses directly after harvest, and the third one was stored in the cold room at +4.5° C. for 72 hours and then at room temperature for 24 hours at +18° C. (simulated shelf life).

Several parameters were measured: brightness (brightness=glossiness−scale from 1 to 9, where 1—very low; 3—low, 5—medium, 7—high, 9—very high), fruit color (internal, external), size of the internal cavity, resistance to bruising and rooting, firmness, soluble solids, titrable acid, organic acids, pH, anthocyanins (anthocyanins content—by pH differential method (Wrolstad R. E. (1976): Colour and pigment analyses in fruit product. Station Bulletin 624, Oregon State University, Corvallis, USA). Polyphenols (total phenolics content—colorimetrically by the method modified by Tsao R. Yang R. (Optimization of a new mobile phase to know the complex and real polyphenolic composition: towards a total phenolic index using high-performance liquid chromatography. J. Chromatogr. A 1018 (2003) 29-40, 29-40).

Among all quality parameters measured, the anthocyanin content and the brightness were the highest in fruits treated with Fluopyram+Trifloxystrobin (for both harvesting dates)—see table below.

As comparison spraying with Switch® was used. Switch is a water dispergable granulate containing 37.5% (w/w) Cyprodinil and 25% (w/w) Fludioxonil.

| | Anthocyanin | Anthocyanin | | Brightness |
|---|---|---|---|---|
| | contents | contents | | After |
| | (mg/100 g) ± | (mg/100 g) ± | | 72 hours |
| | SD* | SD* | | at |
| | 25 Jun. 2009 | 29 Jun. 2009 | Brightness | +4.5° C. |
| | Harvest 1 | Harvest 2 | At harvest | shelf-life |
| Untreated | 42.6 ± 0.7 | 45.6 ± 0.3 | 3.8 a | 3.8 a |
| Fluopyram + | 45.8 ± 0.2 | 49.4 ± 0.2 | 4.1 b | 4.7 b |
| Trifloxystrobin | | | | |
| SC 500 g/L − | | | | |
| 0.8 L/Ha | | | | |
| Switch ® − 1 kg/ha | 39.6 ± 0.2 | 35.7 ± 0.0 | 4.0 ab | 3.8 a |

*SD = Standard deviation

### Example B

### Grapes

A trial was performed to measure the effects of Botrytis cinerea protection program on the quality of the must at harvest.

One trial was carried out in Champagne area (Pinot meunier variety—Row spacing 1.2 m—Canopy height 1.3 m—8333 plants/ha) with 3 usual applications of fungicide to protect against disease at stages cap fall, Bunch beginning to hang and Beginning of ripening. The sprays were realized spray on the two faces of the row with a pneumatic sprayer and the application volume was 200 L/Ha. Grape bunch infestation was evaluated 40 days after the last application. A sample of 50 bunches was assessed: the Incidence or frequency of infestation is calculated (% infested bunches) and the severity (% of infested area) is evaluated (0% infestation—no Botrytis cinerea visible to 100% infestation—entire bunch infested). The average of % infested area is calculated on the 50 bunches.
a) Several parameters were measured at harvesting time: Disease infection, Sugar content, pH, Acid content, NH4, Polyphenols

Among the treatments, the treated plots were well protected against Botrytis cinerea. The quality of the must is therefore increased and especially with desired ingredient polyphenols measured in the must-see table below.

As comparison spraying with Switch® was used. Switch is a water dispergable granulate containing 37.5% (w/w) Cyprodinil and 25% (w/w) Fludioxonil.

| | Severity on | Incidence on | |
|---|---|---|---|
| | bunch* (% | bunch* (% | |
| | infested | infested | Polyphenols in |
| | area) | bunches) | micrograms |
| | Harvest | Harvest | per liter* |
| Untreated | 18 a | 68 a | 9.0 b |
| Fluopyram | 5 b | 30 b | 13.0 a |
| SC 500 g/L − 0.6 L/Ha | | | |
| Switch ® − 1.2 kg/ha | 3 b | 26 b | 11.0 ab |

*figures followed by different letters are significantly different as estimated by the Duncan test 5% (Duncan, D B.; Multiple range and multiple F tests. Biometrics 11:1-42, 1955).

1. A method for increasing the content of one or more desired ingredients in a crop comprising administering to said crop a succinate dehydrogenase inhibitor.

2. The method of claim 1 wherein the succinate dehydrogenase inhibitor is selected from the group consisting of fluopyram, isopyrazam, boscalid, penthiopyrad, penflufen, sedaxane, bixafen, 3-(difluoromethyl)-1-methyl-N-(3′,4′,5′-trifluorobiphenyl-2-yl)-1H-pyrazole-4-carboxamide, and combinations thereof.

3. The method of claim 2 wherein the succinate dehydrogenase inhibitor is fluopyram.

4. The method of claim 1 wherein the crop is selected from the group consisting of cotton; flax; vine; fruit or vegetable crops such as Ericaceae sp., including instance cranberry, blueberry, bilberry and huckleberry; Brassicaceae sp. including cabbage, broccoli, cauliflower, turnip, Chinese cabbage, Brussels sprouts, rapeseed, canola, radish and horseradish; Prunaceae sp. (Amygdalaceae) including plum, cherry, apricot, peach, and almond; Maloideae sp. (Pomoideae) including apple, pear, quince, rowan, loquat; Ribesioidae sp., Juglandaceae sp., Betulaceae sp., Anacardiaceae sp. including mango, sumac, marula and pistachio; Fagaceae sp., Moraceae sp., Oleaceae sp., Actimidaceae sp., Lauraceae sp., Musaceae sp. including banana; Rubiaceae sp. including coffee and borojo; Theaceae sp., Sterculiceae sp., Rutaceae sp. including lemons, lime, oranges and grapefruit; Liliaceae sp., Asteraceae sp. including lettuces; Umbelliferae sp., Cruciferae sp., Chenopodiaceae sp., Cucurbitaceae sp. including melons, gourds, cucurbits, cucumbers, squashes, pumpkins, winter squash, luffas, melons and watermelons; Papilionaceae sp. including peas and soybean; Rosaceae sp. including strawberries, blackberry, raspberry, boysenberry; major crops such as Graminae sp. including maize, lawn or cereals such as wheat, rye, rice, barley and triticale; Asteraceae sp. including sunflower; Cruciferae sp. including colza, Fabacae sp. including peanuts; Solanaceae sp. including potatoes, eggplant, capsicum, paprika, chili pepper, potato, tobacco; Chenopodiaceae sp. including beetroots, spinach, chard; sugarcane (Saccharum spp.), sugar beets (Beta vulgaris), date palm (Phoenix dactylifera), sorghum (Sorghum vulgare) and sugar maple (Acer saccharum), alfalfa, yerba mate, borojo, cocoa tea, green bean, fig, pineapple, hedge apple, mulberry, kiwifruit, guava, lucuma, pomegranate, blackcurrant, redcurrant, gooseberry, papaya, globe artichokes, sweetcorn, kale, collard greens, beet greens, turnip greens, endive; leeks, celery, rhubarb, asparagus, ginger; Jerusalem artichokes, sweet potato, yam bean sprouts, carrots, parsnips, beets, turnips, onions, garlic, shallots, palm, soybean, cotton seed, palm kernel, corn, sunflower seed, peanut, coconut, hazelnut, walnut and other nuts, linseed, rice, sesame, canola and olive horticultural and forest crops; and genetically modified homologues thereof.

5. The method of claim 1, wherein the one or more desired ingredients are selected from the group consisting of sugars, starch, oil, fat, unsaturated fatty acids, fruit acids, polyphenols, anthocyanins and anthocyanidins, vitamins and combinations thereof.

6. The method of claim 5, wherein the sugar is selected from the group consisting of starch, fructose, glucose, sucrose and combinations thereof.

7. The method of claim 5, wherein the vitamin is selected from the group consisting of retinoids and carotenoids (vitamin A), thiamine (vitamin B₁), riboflavin (vitamin B₂), niacin, niacinamide (vitamin B₃), pantothenic acid (vitamin B₅), pyridoxine, pyridoxamine, pyridoxal (vitamin B₆), biotin (vitamin B₇), folic acid, folinic acid (vitamin B₉), ascorbic acid (vitamin C), tocopherols, tocotrienols (vitamin E), phylloquinone, menaquinones (vitamin K) and combinations thereof.

8. The method of claim 1, wherein the one or more desired ingredients are oil and fat.

9. The method of claim 1, wherein the one or more desired ingredients are the unsaturated fatty acids.

10. The method of claim 9, wherein the unsaturated fatty acids are selected from the group consisting of myristoleic acid, palmitoleic acid, oleic acid, linoleic acid, α-linolenic acid, eicosapentaenoic acid, erucic acid, docosahexaenoic acid and combinations thereof.

11. The method of claim 5, wherein the polyphenols are selected from the group consisting of tannins, lignins and flavonoids, such as flavonols, flavones, catechins, flavanones, anthocyanidins isoflavonoids, quercetin and combinations thereof.

12. The method of claim 1, wherein the succinate dehydrogenase inhibitor is applied to the crop prior to the harvest.

13. The method of claim 1, wherein the succinate dehydrogenase inhibitor is applied to the crop at a rate ranging from about 1 to about 250 g/ha-based upon the pure a.s.
